(19) United States
(12) Patent Application Publication
(10) Pub. No.: US 2010/0138232 A1
(43) Pub. Date: Jun. 3, 2010

(54) MOTIVATIONAL SYSTEMS FOR REMOTE PATIENT MANAGEMENT

(75) Inventors: John C. Ryan, Boston, MA (US); Gilbert C. Lemke, Los Gatos, CA (US); Tadashi Egami, Belmont, CA (US)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N. V., Eindhoven (NL)

(21) Appl. No.: 12/527,560

(22) PCT Filed: Jan. 29, 2008
(86) PCT No.: PCT/IB2008/050318

§ 371 Date: Jan. 13, 2010

Related U.S. Application Data
(60) Provisional application No. 60/890,849, filed on Feb. 21, 2007.

(51) Int. Cl. G06Q 50/00; G06Q 30/00; G06Q 10/00; G06F 17/30

(52) U.S. Cl. 705/2; 705/4; 707/748; 707/E17.116

(57) ABSTRACT

A patient management system includes a scheduler (20) configured to schedule engagements with a patient in accordance with a care plan (18). The engagements include at least presentation of audio/video content. An audio/video presentation device (10) is configured to present audio/video content to the patient as directed by the scheduler. An input device (12) is configured to receive patient responses. A response analyzer (34) is configured to analyze at least one patient response to determine patient compliance with a goal of the care plan. An incentives rules engine (40) is configured to generate incentives based on the patient compliance. The incentives rules engine adjusts the generated incentives based on at least one additional factor to enhance motivational value of the generated incentives.

The following relates to the medical arts. It finds particular application in remote patient management systems, but is more generally applicable to any remote patient/healthcare interaction system.

It is known that appropriate behavioral modifications can lead to improved medical intervention outcomes and to health enhancement in general. Such behavioral modifications can include, for example, improved diet, quitting smoking, engaging in regularly scheduled exercise, taking scheduled medications, and so forth. Unfortunately, the medical care paradigm in most countries is not well-suited to administering successful behavioral modifications. A patient is likely to see his or her doctor infrequently at best, perhaps on a monthly or more infrequent basis. A person not under treatment for any specific condition is likely to see his or her doctor even more infrequently. For example, in the United States such a person is likely to have an annual physical examination.

Efforts have been made toward developing out-patient medical monitoring and interventional systems. For example, the Motiva® system (Koninklijke Philips Electronics N.V., Eindhoven, The Netherlands) provides Internet-based or other communication network-based tools for managing remote patients in accordance with individualized care plans. Instructional and motivational videos pertaining to health-related topics are provided on a scheduled basis. Feedback on patient progress is obtained by interactive assessment surveys, information retention tests administered after instructional video presentations, transmission of vital signs or patient weight measured at home by the patient, and other tools.

Pilot studies have shown that Motiva® substantially enhances interventional outcomes and improves quality-of-life metrics for patients. However, the long-term success of Motiva® and other remote health management systems is contingent upon continued long-term participation by patients. In this regard, a patient who is upbeat and cheerful is more likely to participate in automated health management, whereas a patient who is depressed or discouraged is less likely to participate. Accordingly, it has been recognized that patient motivation is an important factor in the success or failure of remote patient management.

One approach for motivating patients is to provide rewards for measurable progress along the patient management program. For example, the Internet-based diet planning organization SparkPeople® has instituted a SparkPoints® program that allocates points to participants based on actions such as dietary program compliance, logging into the SparkPeople® website, reading health-related articles, and so forth. The SparkPeople® website displays the scoring leaders who have accumulated the highest number of points, using alias identifications to provide anonymity.

The approach of SparkPeople® has certain disadvantages as a motivational tool. The number of points acquired (numbering in the tens of thousands for scoring leaders) can become so high as to lose motivational significance. The program is also unlikely to be motivational for persons who are doing poorly. Indeed, the lack of points accumulation by less stellar performers, compared with the massively higher point totals of the scoring leaders, can have a demoralizing effect. Problematically, it is precisely those persons who are doing poorly in the program who typically most need a motivational boost. It is likely that the scoring leaders are already highly motivated, and would perform well even without the points incentive.

Indeed, such problems are inherent in existing scoring systems—highly motivated individuals strive to be scoring leaders and thereby receive additional (typically unnecessary) motivation, while unmotivated or unsuccessful individuals become further discouraged by their failure to keep up with the scoring leaders. Making the obtaining of points easier enables unmotivated or unsuccessful individuals to acquire points more easily, but at the expense of devaluing the acquired scores and reducing the overall effectiveness of the points incentive system.

The following provides a new and improved apparatuses and methods which overcome the above-referenced problems and others.

In accordance with one aspect, a patient management system is disclosed, comprising: a scheduler configured to schedule engagements with a patient in accordance with a care plan, the engagements including at least presentation of audio/video content; an audio/video presentation device configured to present audio/video content to the patient as directed by the scheduler; an input device configured to receive patient responses; a response analyzer configured to analyze at least one patient response to determine patient compliance with a goal of the care plan; and an incentives rules engine configured to generate incentives based on the patient compliance, the incentives rules engine adjusting the generated incentives based on at least one additional factor to enhance motivational value of the generated incentives.

In accordance with another aspect, a patient management method is disclosed, comprising: generating a care plan for a patient; engaging the patient in accordance with the care plan, said engaging including at least presenting audio-video content to the patient in accordance with the care plan; quantifying progress of the patient in following the care plan using at least one patient metric; and accumulating incentives based on the at least one patient metric and at least one additional factor selected to enhance motivational value of the accumulating incentives.

In accordance with another aspect, a method for publishing a collection of scores is disclosed, the method comprising: resealing the scores to compress a range of the scores while retaining the ordering of the scores from lowest score to highest score; and publishing the resealed scores.

In accordance with another aspect, a method is disclosed of adjusting an insurance premium assigned to a patient, the method comprising: generating a care plan for a patient; engaging the patient in accordance with the care plan, said engaging including at least presenting audio-video content to the patient in accordance with the care plan; quantifying progress of the patient in following the care plan using at least one patient metric; accumulating incentives based at least on the at least one patient metric; and adjusting the insurance premium assigned to the patient downward by an amount determined based on the accumulated incentives.

One advantage resides in providing incentives-based motivation in remote patient management that is effective for persons performing poorly in the patient care plan.

Another advantage resides in providing incentives-based motivation that is effective for patients who are performing poorly.

Another advantage resides in providing scores publication in a form that does not discourage poor performers, while retaining motivational aspects associated with competition engendered by comparative scores publication.

Another advantage resides in providing incentives-based motivation that is keyed to the mood of the patient.

Another advantage resides in providing incentives-based motivation using a type of incentives that is selected based on a dominant patient characteristic.

Still further advantages of the present invention will be appreciated to those of ordinary skill in the art upon reading and understand the following detailed description.

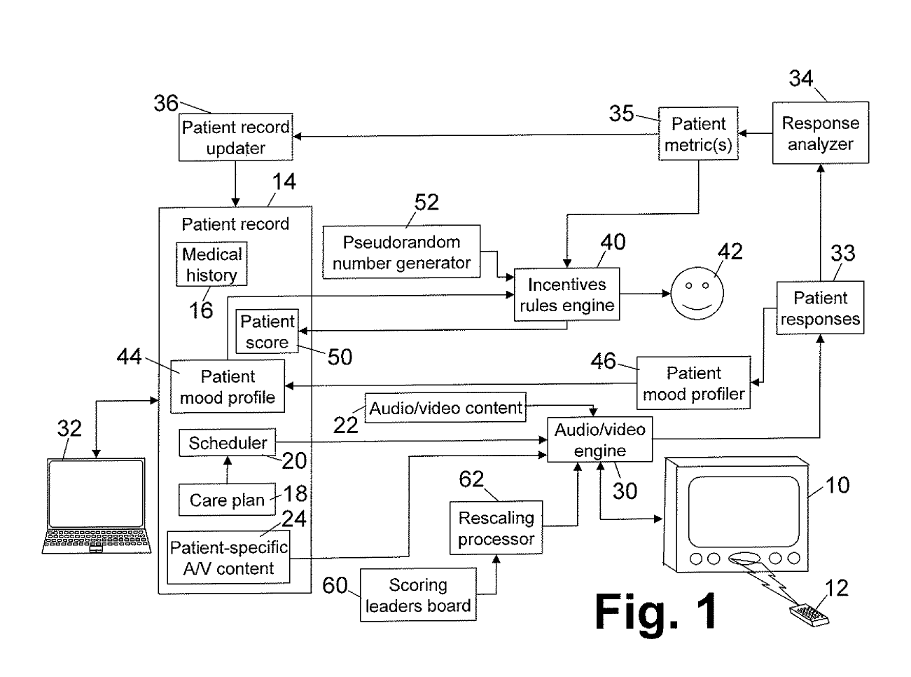

FIG. 1 diagrammatically shows a remote patient management system including an incentives-based motivational mechanism.

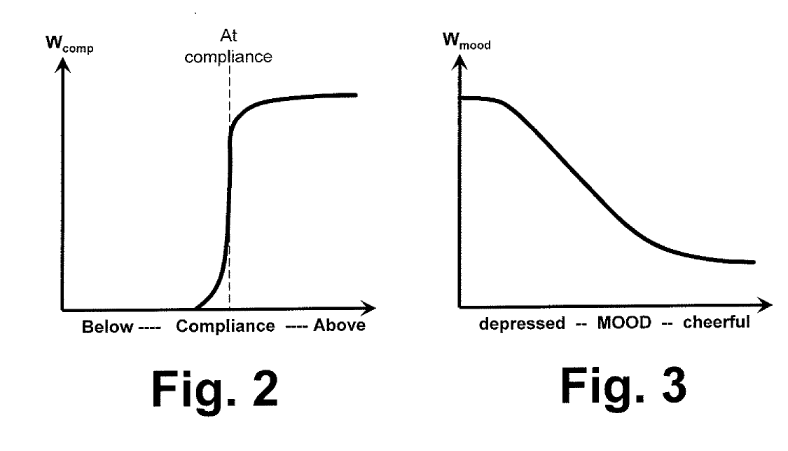

FIG. 2 diagrammatically shows unadjusted incentives generated based on compliance with a goal of the patient's care plan.

FIG. 3 diagrammatically shows an incentives weighting adjustment based on patient mood.

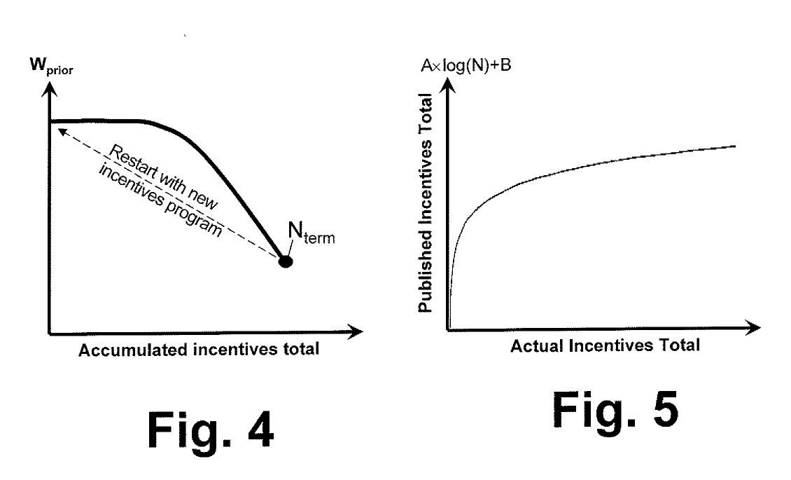

FIG. 4 diagrammatically shows an incentives weighting adjustment based on accumulated points or score.

FIG. 5 diagrammatically shows a resealing function suitably applied to scores prior to publication.

With reference to FIG. 1, a remote patient management system provides automated or semi-automated information transfer, patient interaction, and other aspects promoting patient health and well-being. The term “patient” as used herein is to be broadly construed as encompassing any person receiving assistance from the remote patient management system. Such patients may include chronically ill persons, persons recovering from surgery or illness, generally healthy persons receiving assistance from the remote patient management system to promote wellness or health maintenance, or so forth. The patient may be an out-patient living at home, or in an assisted living setting, or in a nursing home, or so forth. Alternatively, the patient may be an in-patient who has been admitted to a hospital or other medical care facility.

The patient has access to an audio/video presentation device, such as an illustrated television 10, or a cellular telephone with a graphical display, or a personal data assistant (PDA) with a graphical display, or a personal music player having video playback capability, or so forth. In some embodiments, the patient may selectively make use of more than one such audio/video presentation device in accessing the remote patient management system, for example using the illustrated television 10 when at home, but using a cellular telephone when away from home. The audio/video presentation device typically has a primary function separate from the patient management system, and also operates to present audio/video content chosen by the patient management system. For example, the television 10 retains its primary function of presenting broadcast television (optionally supplied via a cable network, satellite network, or so forth) and optionally presenting DVD playback or other non-broadcast content. The television 10 additionally is configured to present content provided by the remote patient management system. Such a dual-functionality audio/video presentation device has advantages such as generally being familiar to the patient, reducing space occupancy, and so forth. However, it is also contemplated for the audio/video presentation device to be a dedicated device that is used solely to present audio/video content provided by the remote patient management system.

The patient also has access to a response input device, such as an illustrated handheld remote controller 12, a keypad of a cellular telephone or PDA, the user interface of a personal music player, or so forth. The response input device has functionality including controlling the audio/video presentation device and providing patient responses to the remote patient management system. Typically, the same response input device is used for both functions—for example, the remote controller 12 may be configured to control the television 10 (such as to select a channel for viewing, change the volume, and so forth) and also to provide patient responses to the remote patient management system. Similarly, the keypad of a cellular telephone may be configured to control the telephone (such as inputting a telephone number to call, changing the speaker volume, and so forth) and also to provide patient responses to the remote patient management system. Using a single device for both functions is typically convenient for the patient; however, it is contemplated to have separate devices for performing control of the audio/video presentation device and for providing patient responses to the remote patient management system. Such a separate arrangement may be more practical for retrofitting an existing television or other audio/video presentation device for operation in conjunction with the remote patient management system. If the audio/video presentation device is a dedicated device used solely to present audio/video content provided by the remote patient management system, then the response input device is typically also a dedicated device.

The remote patient management system is personalized—each patient has an associated patient record 14 which is typically in electronic form, although some portions may additionally or alternatively be in printed form. The patient record typically includes a medical history 16 (which may or may not be complete) and a care plan 18 that provides information on interventional engagements that are scheduled for the patient, along with one or more goals that are intended to be accomplished by such interventional engagement. A scheduler 20 schedules audio/video content for presentation to the patient. The scheduled audio/video content may come from various sources. For example, scheduled content may be retrieved from an audio/video content database 22, containing content such as videos on how to stop smoking, weight loss videos, exercise videos, motivational videos, interactive survey videos, and so forth. Scheduled content may also include personalized audio/video content 24, such as a video message from the patient's doctor, or from a nurse, or so forth. The optional personalized audio/video content 24 advantageously provides the patient with personalized contact with medical professionals. The optional personalized audio/video content 24 optionally may also include personal messages from other persons being assisted by the remote patient management system. Such personal messages are contemplated as tools for establishing support networks amongst patients with similar conditions, as tools to promote socializing of home-bound or otherwise socially isolated patients, and so forth.

The scheduler 20 selects content scheduled for presentation based on the care plan 18. For example, the care plan 18 may include a list of stored content from the database 22 along with a presentation time information that may be absolute (for example, indicating that video “x” should be presented on Dec. 14, 2008) or relative (for example, indicating an ordering of presentation without specific dates or times) or some combination of absolute and relative timing information. Personalized messages from the personalized content database 24 may be pre-scheduled (for example, the doctor may record a message for the patient on a weekly or otherwise scheduled time basis) or extemporaneous (for example, a nurse reviewing the patient's record 14 identifies information that should be given to the patient and records a suitable message). In the extemporaneous case, the message is typically presented as soon as practical.

An audio/video engine 30 handles presentation of the scheduled content. In some embodiments, the audio/video engine 30 has substantial processing capability, for example being embodied as a control box connected with the television 10, and the audio/video engine 30 implements a graphical user interface providing the patient with a menu of options for viewing. In such an arrangement, the available scheduled audio/video content (such as videos, video messages, video surveys, or so forth) are identified to the patient via the graphical user interface, and the patient can select which content to be presented. In other embodiments, the audio/video engine 30 may include less processing capability, and may merely serve as a formatting device or other conduit for channeling the scheduled audio/video content into the television 10 or other presentation device.

It is to be appreciated that the physical and logical layout of the system components can vary. The audio/video presentation device should be in the vicinity of the patient, such as in the patient's home in the case of a television, or typically carried with the patient in the case of a cellular telephone, PDA, portable music player, or the like. The audio/video engine 30 can be located in the patient's home, or located in the presentation device as software executing on a processor of the presentation device (for example, a program executed by the processor of a cellular telephone, PDA, or the like), or located at a remote server that, for example, communicates with the presentation device via the Internet, a cellular telephone network, or the like. The patient record 14 is typically accessible by medical professionals via a computer 32 or other interface located at a hospital, doctor's office, or other medical facility. However, the patient record 14 may be stored at such a medical facility or elsewhere. In some embodiments, the patient record 14 or portions thereof may be stored on a hard disk or other storage of the audio/video engine 30. The various components of the patient record 14 can be physically or logically separate or physically or logically integrated. Thus, for example, the medical history 16 may be stored in a secure hospital database, while the care plan 18 and scheduler 20 may be stored in a dedicated secure server hosting the remote patient management system.

The care plan 18 is suitably constructed by a nurse, doctor, or other medical or administrative person with at least some personalization to the patient. For example, the patient may be identified as a non-smoker, moderately overweight, having a family history of cardiac disease, and having a less than ideal diet. The nurse, doctor, or other medical or administrative person receives this information and constructs the care plan 18 by selecting for presentation pre-recorded modules from the audio/video content database 22 relating to basic operation of the system from the patient end, relating to dieting and cardiac disease prevention, and motivational videos relating to these topics, and schedules these for presentation, preferably interspersed with interactive patient surveys, vital sign measurement request videos, or other interactive modules constructed to elicit patient feedback. The nurse, doctor, or other medical or administrative person optionally further records patient-specific audio/video content such as a welcome message including information on the patient's personal contact at the remote patient management system (optionally this may be the person recording the message), and further inserts this into the care plan schedule. At the specified times, the scheduler 20 conveys the scheduled audio/video content to the audio/video engine 30 for presentation to the patient.

When an interactive survey, vital sign measurement request video, or other interactive module is presented, the patient uses the handheld remote controller 12 or other patient response device to provide the requested feedback. For example, an interactive survey may display a question with a list of several answer options (e.g., “How are you feeling today?” with answer options including “cheerful”, “so-so”, “a bit down”, and “depressed”) and the patient presses “up” and “down” arrow keys on the remote controller 12 to move amongst these selections and presses the “enter” key to make the selection. In the case of a vital sign measurement request video, the patient is requested, for example, to take his or her pulse, and then is asked to enter the measured pulse using the numeric buttons of the handheld remote 12. The resulting patient responses 33 are conveyed to a response analyzer 34, which in FIG. 1 is shown as a separate component but which optionally is integrated into the scheduler or other component of the remote patient management system. The response analyzer 34 outputs a patient metric or plurality of patient metrics 35. The patient metrics 35 may include unprocessed responses (such as the measured pulse), processing results (such as a cumulative score attained by the patient on a survey), or some combination of unprocessed and processed results. A patient record updater 36 updates the patient record 14 based on the patient metrics 36. Such updating may include, for example, adding a measured vital sign reading to the medical history 16, updating the care plan 18 based on the patient metrics 35, or so forth. As an example of the latter situation, if the patient scored poorly on a survey, the care plan 18 may be updated to schedule a repetition of one or more videos that provide instruction relating to the topic of the survey, so as to reinforce or ensure that that patient learns the relevant information. Similarly, if a vital sign measurement is problematic (for example, a high blood pressure reading) then an additional video or set of videos may be scheduled directed toward behavior modification intended to correct an underlying problem reflected by the problematic vital sign measurement (for example, a relaxation video intended to address high stress that may be causing the high blood pressure reading).

The remote patient management system described with reference to FIG. 1 and including the various components 10, 12, 14, 22, 30, 32, 34, 36 is an illustrative example. Other systems can be constructed for the purpose of implementing a patient management method including generating a care plan for a patient and engaging the patient in accordance with the care plan including presenting audio-video content to the patient in accordance with a care plan schedule and receiving patient responses. As used herein, the patient responses are intended to encompass any feedback provided by the patient. For example, merely turning on the television 10 to receive a scheduled video may be considered to be a patient response. In some embodiments, the patient responses are contemplated to include automatically acquired patient data, such as an SpO₂ blood oxygenation reading acquired automatically by an SpO₂ meter operatively connected with the Internet or another communication pathway.

With continuing reference to FIG. 1, the illustrated remote patient management system includes an incentives-based motivational mechanism. An incentives rule engine 40 receives the patient metrics 35 and computes suitable incentives to motivate the patient toward further progress. The type of incentive is suitably dependent on a dominant patient characteristic. The patient characteristic may be determined, for example, based on answers to a survey including questions designed to elicit information about characteristics of the patient. The response analyzer 34 suitably analyzes the responses to extract a dominant patient characteristic, and the patient record updater 36 updates the patient record 14 with the dominant patient characteristic determined by such analysis. Alternatively, the nurse, doctor, or other medical or administrative person constructing the care plan 18 can input the dominant patient characteristic into the patient record 14 based on that person's direct or indirect knowledge about the patient.

TABLE 1

| Patient characteristic | Type of Incentive |
|---|---|
| Hypochondriac | “Happy face” counters |
| Fitness enthusiast | Health outcome forecast |
| Financially limited | Insurance premium deduction |
| Child | Video game time |
| House-bound | Movie credits |

Table 1 shows some illustrative incentive types that are advantageous for patients having various identified characteristics. The selection of the incentive type based on patient characteristic can be advantageous in producing highly motivational incentives. For example, providing incentives in the form of health outcome forecasts can be highly motivational for patients who are fitness enthusiasts having the opinion that they are “in control” and able to improve their own health. For this incentive type, the incentives rules engine 40 suitably computes a health outcome forecast based on the patient metrics and a suitable algorithm or formula relating the patient metrics to statistical patient health outcome forecasts. For example, every five pounds of weight loss may be related to a certain increase in life expectancy. On the other hand, a patient who is a hypochondriac probably should not be reminded of health outcome issues since this may feed the hypochondriac tendency. For the hypochondriac a motivation in the form of “happy face” counters displayed on the audio/video device 10 during patient engagement sessions of the remote health management system may be more motivational. Such displayed “happy face” counters remind the hypochondriac patient that he or she is in fact doing well.

Similarly, incentives in the form of an insurance premium deduction can be highly motivational for patients of limited financial means, but may be less motivational for wealthy patients. A child may find incentives in the form of video game time (suitably “cashed in” by playing a video game via the television 10 and optionally supported by the audio/video engine 30) to be highly motivational, whereas an adult may find such an incentive to have little or no motivational value. As yet another illustrative example, a house-bound patient may find free movie credits (suitably “cashed in” by requesting movies from a cable service provider operating in agreement with the provider of the remote health management system) to be highly motivational. In FIG. 1 generated incentives 42 are diagrammatically indicated.

The rules applied by the incentives rules engine 40 are selected to enhance motivational value of the generated incentives 42. In some embodiments, the generated incentives are adjusted based on a patient mood profile 44 determined and occasionally updated by a patient mood profiler 46 based on selected portions of the patient responses 33. For example, the presented audio/video content may include a survey including questions designed to elicit information about the patient's mood, and this information is then processed by the patient mood profiler 46 to update the patient mood profile 44. In the illustrated embodiments, patient mood is designated as a parameter ranging from depressed to cheerful; however, more complex representations of patient mood are contemplated, for example to account for the patient's level of hope (for example, represented on a scale between despairing and confident), or to account for a patient's level of social interaction (for example, represented on a scale between isolated and overwhelmed with visitors), or so forth. Other additional factors that may be accounted for in adjusting the generated incentives to enhance motivational value include the accumulated incentives total, sometimes referred to herein as a score 50, and a random factor suitably introduced by a random or pseudorandom number generator 52.

With continuing reference to FIG. 1 and with further reference to FIG. 2, the illustrative rule engine 40 awards incentives (before adjustment) based on the patient being at or above compliance with one or more goals of the care plan 18. Some examples of suitable goals include: an attendance goal (for example, the patient may receive incentives for each video that is watched); a performance goal (for example, a patient on a weight loss program may receive incentives in an amount based on whether and how much weight has been lost); a behavior modification goal (for example, a patient who smokes may receive incentives based on how long it has been since the patient last smoked a cigarette); an achievement goal (for example, the patient may receive incentives each time he or she successfully reports a measured blood pressure reading); or so forth. Compliance can be detected in various ways. For attendance goals, compliance may be automatically detected based on the patient's operation of the audio/video presentation device 10, the audio/video engine 30, or so forth. For other goals, detection of compliance or non-compliance may rely upon the patient responses 33, such as answers to survey questions or provided vital sign, weight, or other personal measurements.

The measure of incentives can be binary (for example, the patient either watches the video and receives incentive points, or does not watch and hence receives no points) or can be analog (for example, the amount of incentive points received before any adjustments may be based on the number of pounds of weight that has been lost). Where the goal is analog, it is contemplated to provide some incentive points if the patient is below compliance but close to compliance, as diagrammatically illustrated in FIG. 2. For example, the goal in FIG. 2 may be to lose five pounds over a period of one month. Thus, the patient would be at compliance if he or she loses precisely five pounds, and would be above compliance if he or she loses anything greater than five points. On the other hand, if the patient loses only four pounds, then the patient is not at compliance but is close to compliance. In such a case, some amount of incentives is received that is however less than what would have been received if the patient had been at or above compliance.

To encourage compliance with goals, the incentives accumulation should sharply increase at the compliance point, as shown in FIG. 2. Otherwise, the patient may be encouraged to be satisfied with performance close to, but not meeting, the goal. Optionally, the incentives accumulation increases in the analog case as the performance increases above the goal. As shown in FIG. 2, this increase is optionally concave downward such that the rate of incentives accumulation decreases as the patient goes further above the compliance with the goal. This optional decrease has the advantage that if the patient is substantially exceeding the compliance goal, then the patient is likely already highly motivated at least respective to this goal, and accordingly the motivational value of providing additional incentives accumulation is limited.

The incentives accumulated in accordance with FIG. 2 are not adjusted to enhance the motivational value of the incentives. With reference to FIGS. 3 and 4, some adjustments to the generated incentives are described which are expected to enhance the motivational value of the adjusted incentives 42.

With continuing reference to FIG. 1 and with further reference to FIG. 3, in an illustrated embodiment the generated incentives are adjusted based on the patient mood profile 44 by using a mood weighting, denoted W_{mood}, that ranges from a relatively larger value when the patient is depressed to a relatively smaller value when the patient is cheerful. Thus, if the generated incentives before adjustment is represented by N_{I}, then the adjusted incentives is suitably given by the product W_{mood}×N_{I}. In the illustrative embodiment, the mood weighting W_{mood} is selected such that the patient will generally receive more incentives when the patient is depressed as compared with when the patient is cheerful. This is advantageous because the patient is more likely to benefit from additional motivation from enhanced incentives when the patient is depressed, as compared with when the patient is cheerful. Similar relationships can be estimated for other mood representations: for example, more incentives should generally be provided when the patient is feeling hopeless as compared with when the patient is feeling hopeful. More generally, the incentives rules engine 40 adjusts the generated incentives generally upward responsive to the patient mood profiler 46 indicating that the patient is in a demotivated mood, such as depressed, hopeless, afraid, or so forth, and generally downward responsive to the patient mood profiler 46 indicating that the patient is in a motivated mood, such as cheerful, hopeful, encouraged, or so forth.

With continuing reference to FIG. 1 and with further reference to FIG. 4, in an illustrated embodiment the generated incentives are adjusted based on the patient score 50, that is, based on the previously accumulated incentives total. The adjustment is made using a prior incentives total weighting, denoted Wₚᵣᵢₒᵣ, that starts out at a relatively large value when the patient has accumulated no or few incentives (that is, has a low score), and decreases as the patient score 50 increases. If the generated incentives before adjustment is represented by N_{I}, then the adjusted incentives is suitably given by the product Wₚᵣᵢₒᵣ×N_{I}. If adjustments are to be made for both mood and prior accumulated incentives (Wₚᵣᵢₒᵣ), then the adjusted incentives is suitably given by W_{mood}×Wₚᵣᵢₒᵣ×N_{I}. In the illustrative embodiment, Wₚᵣᵢₒᵣ is selected such that the patient will generally receive more incentives early on, with the rate of incentives accumulation falling off in accordance with Wₚᵣᵢₒᵣ as the patient progresses. This is advantageous because the patient is more likely to benefit more from additional motivation early in the program as compared with when the program is well-established.

In some embodiments, once the patient reaches a certain accumulation of incentives, that is, reaches a certain terminal score denoted by Nₜₑᵣₘ in FIG. 4, or satisfies another level criterion, the incentives program terminates and restarts with a new incentives program. This can be done by resetting the incentives total to zero or another selected starting point when the incentives total reaches the level criterion Nₜₑᵣₘ, and restarting the quantifying and accumulating of incentives starting at the reset incentives total using a different progress metric, a different motivational enhancement adjustment factor or factors, or some combination of these changes. For example, at a “Level 1” the patient may earn incentives merely by watching the videos and answering the surveys, regardless of progress in behavioral modification or physical condition. At some point, the patient reaches the incentives level Nₜₑᵣₘ and moves to a “Level 2” where the incentives earned by merely watching videos and answering surveys decreases or is eliminated, and points are instead gained by meeting performance goals respective to behavioral modification or physical condition.

On the other hand, in some embodiments there may be provisions made to lower goals with which the patient consistently fails to comply. For example, if the “at compliance” line of FIG. 2 indicates a target amount of daily exercise, and the patient consistently fails to meet this target, then the target may be lowered. The advantage of doing this is that the patient may occasionally meet the lowered goal and accordingly receive incentives that motivate the patient toward more progress in getting daily exercise.

With reference to FIG. 1, in some embodiments the adjusting of the generated incentives to enhance motivational value of the generated incentives is based in part on a randomizing factor. In illustrative FIG. 1, this randomizing factor is provided by the pseudorandom number generator 52. The unexpected nature of random adjustments of incentives can be motivational, as the patient is constantly hoping to get an unexpected prize in the form of randomly inflated incentives.

With continuing reference to FIG. 1 and with further reference to FIG. 5, in some embodiments, incentive totals may be published, or a sub-set of incentive totals may be published, such as a “scoring leaders board” 60 indicated diagrammatically in FIG. 1 listing the highest scores or incentive totals. The publication may be via the Internet, or via the audio/video engine 30 and presentation device 10 as indicated in FIG. 1, or so forth. A difficulty with publishing scores is that persons doing poorly relative to other participants may be demoralized by seeing the high scores of those doing much better. Accordingly, a rescaling processor 62 optionally rescales the scores or incentive totals prior to publication. The rescaling involves adjusting each published incentive total by a monotonically increasing, concave downward rescaling function that reduces higher scores relative to lower scores, while maintaining the ordering of scores. That is, while the difference between scores is advantageously reduced by the rescaling processor 62, it should always be the case that if score “A” is higher than score “B”, then rescaled score “A” should also be higher than rescaled score “B”. To be otherwise would compromise the integrity of comparisons between published scores. The ordering property is ensured by using a rescaling function that is monotonically increasing over the interval over which it is applicable (that is, the interval over which scores may exist). At the same time, it is desired for the rescaling to relatively compress the range of the higher scores compared with lower scores prior to publication. This compression is achieved by the concave downward property, which ensures that the derivative of the rescaling function is monotonically decreasing over the interval over which it is applicable.

Some suitable monotonically increasing, concave downward rescaling functions include logarithm-based rescaling functions such as that shown in FIG. 5. This function is of the form:

Resealed score=A×log(score)+B (1),

where A and B are constants and “log( )” is a logarithmic function, such as a base-10 logarithm (that is, “log₁₀( )”), a natural logarithm (that is, “ln( )”), or so forth. Table 2 shows selected scores and resealed scores for the logarithmic rescaling function of Equation (1) in which the “log( )” function is base ten and A=B=1. As shown in Table 2, the scores range from a low value of 1 to a high value of 20,000, representing a range of four orders of magnitude. One can easily imagine Sally, who has a score of 100, being discouraged by publication of the much higher scores of Matt and Jill at 15,000 and 20,000, respectively. On the other hand, by publishing the resealed scores which range from a low value of 1.00 to a high value of 5.30, Sally is not discouraged because her resealed score of 3.00 is within a reasonable range of the published resealed scores of Matt and Jill at 5.18 and 5.30, respectively.

TABLE 2

| | Score | Rescaled score |
|---|---|---|
| Alias | (S) | (S_{rescale} = log₁₀(S) + 1) |
| Tom | 1 | 1.00 |
| Dick | 5 | 1.70 |
| Harry | 10 | 2.00 |
| Sally | 100 | 3.00 |
| Bobby | 500 | 3.70 |
| Chris | 1000 | 4.00 |
| Jeannette | 2000 | 4.30 |
| Tammy | 10000 | 5.00 |
| Matt | 15000 | 5.18 |
| Jill | 20000 | 5.30 |

The logarithmic-based rescaling functions are illustrative examples. Other monotonically increasing, concave downward rescaling functions can be used.

Moreover, the disclosed systems and methods for rescaling of incentives totals before publication are applicable to publication of scores in general, including but not limited to scores corresponding to incentive totals in the context of a remote patient management system. For example, the disclosed systems and methods for rescaling scores may be applied to competitive athletic scores such as finishing times in races, publication of academic grade scores, or so forth. The rescaling advantageously enables publication that engenders competitive motivation, without unduly discouraging those persons having low scores. The rescaled scores retain the ordering of scores so as to foster a desire to improve as compared with peers, interpersonal competition, and other motivational aspects. As illustrated in Table 2, a logarithmic-based rescaling advantageously can compress scores spanning a range of several orders of magnitude into rescaled scores having a range of less than one order of magnitude. On the other hand, where the scores have a smaller range, such as finishing times in a race, a less aggressive monotonically increasing, concave downward rescaling function can be used, such as sqrt(x) where x is the score and sqrt(x) is the square-root of x. The less aggressive sqrt(x) rescaling function has the effect of reducing a score range of about a factor of five to a score range of about a factor of two.

TABLE 3

| | Finishing time | Rescaled finishing time |
|---|---|---|
| Alias | (min) | Time_{rescale} = sqrt(time) |
| Dick | 39.4 | 6.28 |
| Harry | 39.9 | 6.32 |
| Sally | 44.2 | 6.65 |
| Bobby | 51.0 | 7.14 |
| Chris | 52.2 | 7.22 |
| Jeannette | 56.9 | 7.54 |
| Tammy | 59.3 | 7.70 |
| Matt | 146.23 | 12.09 |
| Jill | 184.34 | 13.58 |

While the rescaled scores are published, each person is optionally informed of his or her score without such rescaling. For example, if the score is reflective of a meaningful quantity, such as a finishing time in a race, the score has meaning that the rescaled score does not.

In the illustrated examples, the accumulating incentives are quantified by the single illustrated patient score 50. In other contemplated embodiments, there may be two or more different scores maintained, to reflect two or more different and distinct goals. For example, one patient score may reflect progress toward quitting smoking, while a separate patient score may reflect progress toward losing weight. The systems and methods disclosed herein are readily applied to such a situation by applying the incentives rules engine 40 to each goal to produce separate, and separately accumulated, incentives. For the correction Wₚᵣᵢₒᵣ, the accumulated incentives total for the quitting smoking goal is used in adjusting the generated incentives for the quitting smoking goal, while the accumulated incentives total for the losing weight goal is used in adjusting the generated incentives for the losing weight goal. In some embodiments, a nurse, doctor, or other medical professional can review the incentives acquired by the patient using the computer 32 or another suitable interface, or can view the mood profile to assess the patient's psychological condition, or can view other aspects of the patient record 14 to assess the patient's condition and progress. In some embodiments, there may be a monetary prize or other valuable award given to the patient for reaching a certain incentives total.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

Having thus described the preferred embodiments, the invention is now claimed to be:

1. A patient management system comprising:
a scheduler (20) configured to schedule engagements with a patient in accordance with a care plan (18), the engagements including at least presentation of audio/video content;
an audio/video presentation device (10) configured to present audio/video content to the patient as directed by the scheduler;
an input device (12) configured to receive patient responses;
a response analyzer (34) configured to analyze at least one patient response to determine patient compliance with a goal of the care plan; and
an incentives rules engine (40) configured to generate incentives based on the patient compliance, the incentives rules engine adjusting the generated incentives based on at least one additional factor to enhance motivational value of the generated incentives.

2. The patient management system as set forth in claim 1, wherein the audio/video presentation device includes a television (10) and the input device includes a handheld remote controller (12) configured to operate at least the television.

3. The patient management system as set forth in claim 1, further including:
a patient mood profiler (46) configured to analyze at least one patient response to determine a patient mood, the patient mood being used by the incentives rules engine (40) in adjusting the generated incentives to enhance motivational value.

4. The patient management system as set forth in claim 3, wherein the incentives rules engine (40) adjusts the generated incentives generally upward responsive to the patient mood profiler (46) indicating that the patient is in a demotivated mood, and generally downward responsive to the patient mood profiler indicating that the patient is motivated mood.

5. The patient management system as set forth in claim 1, wherein the incentives rules engine (40) determines a type of the generated incentives based on patient characteristic.

6. The patient management system as set forth in claim 1, wherein the at least one additional factor includes an accumulated incentives total (50), and the incentives rules engine (40) generally adjusts the generated incentives downward as the incentives total increases.

7. The patient management system as set forth in claim 1, further including:
a resealing processor (62) that rescales incentive totals (60) before publication, the resealed incentive totals being published using the audio/video presentation device (10).

8. A patient management method comprising:
generating a care plan (18) for a patient;
engaging the patient in accordance with the care plan, said engaging including at least presenting audio-video content to the patient in accordance with the care plan;
quantifying progress of the patient in following the care plan using at least one patient metric; and
accumulating incentives based on the at least one patient metric and at least one additional factor selected to enhance motivational value of the accumulating incentives.

9. The patient management method as set forth in claim 8, wherein the accumulating includes:
generally decreasing a rate of the accumulating as an incentives total (50) generated by the accumulating increases.

10. The patient management method as set forth in claim 8, wherein the accumulating includes at least one of:
generally increasing a rate of the accumulating responsive to an indication that a mood of the patient is demotivated, and
generally decreasing a rate of the accumulating responsive to an indication that a mood of the patient is motivated.

11. The patient management method as set forth in claim 10, further including:
determining a mood of the patient based on patient responses received during the engaging of the patient in accordance with the care plan.

12. The patient management method as set forth in claim 8, wherein the accumulating includes:
accumulating incentives based on comparison of the patient metric with a compliance threshold.

13. The patient management method as set forth in claim 12, further including:
responsive to the accumulating of incentives being too slow, adjusting the compliance threshold to enhance the accumulating.

14. The patient management method as set forth in claim 8, wherein the accumulating includes:
continuing the quantifying of progress and the accumulating of incentives until an incentives total resulting from the accumulating satisfies a level criterion;
resetting the incentives total responsive to the incentives total satisfying the level criterion; and
restarting the quantifying and accumulating using at least one of (i) a different at least one patient metric, and (ii) a different at least one additional factor.

15. The patient management method as set forth in claim 8, further including:
publishing a rescaled incentive total that is rescaled by a monotonically increasing, concave downward rescaling function.

16. The patient management method as set forth in claim 15, further including:
publishing a rescaled incentive total that is rescaled by a logarithmic rescaling function.

17. The patient management method as set forth in claim 8, further including:
manifesting the accumulated incentives as one of displayed “happy face” counters, a health outcome forecast for the patient, an insurance premium deduction for the patient, video game time allocated to the patient, and movie credits allocated to the patient.

18. A patient management system implementing the patient management method as set forth in claim 8.

19. A method for publishing a collection of scores, the method comprising:
rescaling the scores to compress a range of the scores while retaining the ordering of the scores from lowest score to highest score; and
publishing the rescaled scores.

20. The method as set forth in claim 19, wherein the rescaling comprises:
applying a monotonically increasing, concave downward rescaling function to the scores to generate the rescaled scores.

21. The method as set forth in claim 19, wherein the rescaling comprises:
applying a logarithm-based rescaling function to the scores to generate the rescaled scores.

22. A method of adjusting an insurance premium assigned to a patient, the method comprising:
generating a care plan (18) for a patient;
engaging the patient in accordance with the care plan, said engaging including at least presenting audio-video content to the patient in accordance with the care plan;
quantifying progress of the patient in following the care plan using at least one patient metric;
accumulating incentives based at least on the at least one patient metric; and
adjusting the insurance premium assigned to the patient downward by an amount determined based on the accumulated incentives.

23. The method as set forth in claim 22, wherein the accumulating of incentives is further based on at least one additional factor selected to enhance motivational value of the accumulating.

24. The method as set forth in claim 23, wherein the at least one additional factor selected to enhance motivational value of the accumulating includes a patient mood metric indicative of a motivational level of the patient.
